(19) United States
(12) Patent Application Publication
(10) Pub. No.: US 2006/0093462 A1
(43) Pub. Date: May 4, 2006

(54) Self-lift scooter

(76) Inventor: Fernando Pradenas, Cathedral City, CA (US)

Correspondence Address: Steven W. Webb;Law Offices of Steven W. Webb, 655 2nd Street, Encinitas, CA, 92024, US

(21) Appl. No.: 10/979,025

(22) Filed: Nov. 2, 2004

(51) Int. Cl. B60P 9/00

(52) U.S. Cl. 414/462

(57) ABSTRACT

A novel scooter lifting mechanism is proposed using a lifting motor and worm gear on the scooter itself to lift the scooter into position to be carried on a vehicle. The self-lifting scooter uses its own battery power to operate the lifting mechanism. The bracket that carries the scooter is attached to the rear of a standard automobile, and can be removed and stored in the vehicle when not in use.

### FIELD OF THE INVENTION

This invention relates to devices and means for enabling a larger vehicle to carry a smaller vehicle attached to it removably. In particular, this invention relates to devices for carrying personal mobility devices such as scooters on the back of automobiles.

### BACKGROUND OF THE INVENTION

Personal scooters are a popular means by which mobility-limited individuals can get around over long distances that would otherwise have to be walked. These scooters are transportable within other vehicles, such as a van, or attached to the rear of a car, truck, or van. The method of attachment is to have a lifter that picks up the scooter and holds it removably but securely at the back bumper.

Typical of the prior art is Jones et al. U.S. Pat. No. 5,482,424 which teaches a powered lift for wheelchairs attached to the rear of an automobile and Meyer U.S. Pat. No. 5,466,111 which shows a self-lifting wheelchair that uses the driver's door to position itself in an automobile. Steiger and Johnson in U.S. Pat. No. 4,180,363 show a self-lifting forklift that can lift or lower itself onto/off of a truck bed. All of these require complex support mechanisms or modifications to a vehicle and do not apply to personal scooters carried outside of vehicle.

The present invention is a simple adaptation to an existing scooter design that uses a standard trailer hitch and support arm to attach and lift itself onto an automobile. Therefore, it is clear that the prior art for scooter lifters does not include the present solution to the scooter transportation problem.

### SUMMARY OF THE INVENTION

The present invention is an electrically-powered worm gear mechanism attached to a standard scooter or designed and manufactured into it that permits the scooter to lift itself against a fixed support arm connected to the rear of the carrying vehicle. This invention is designed to be used with the scooter standing on its rear wheels with the front end elevated vertically. The worm gear drive axis runs from the front of the scooter to the rear, with the worm gear motor placed at the rear of the scooter.

To attach the scooter to the fixed support arm connected to the carrying vehicle, the scooter must be rotated into a vertical position on its rear wheels by lifting the front end of the scooter. The worm gear mechanism is an industry-standard, high-efficiency epicyclic ball screw with integral freewheeling at both the down and up stroke, eliminating limit switches and increasing reliability. The particular model used in the prototype unit has a load capacity of 500 pounds, and lifts the scooter 22 inches above the ground. When power is applied to the lift motor, through a momentary toggle switch, it causes a bracket with attaching pin to be moved down the screw from the front of the scooter towards the rear. The attaching pin is first mated to the support arm, in the preferred embodiment inserted into a cylindrical hollow connector, before the worm gear mechanism is activated.

There are many different solutions to attaching the scooter to the support arm and these include automatic locking and quick disconnect features.

### DESCRIPTION OF THE DRAWINGS

FIG. 1 is a side view of the invention as it is attached to a scooter.

FIG. 2 is a side view showing how the scooter connects to an automobile.

FIG. 3 is a side view of the scooter lifting itself off the ground

FIG. 4 is a perspective view of the worm gear motor and bracket.

FIG. 5 is a perspective view of the support arm as it is attached to the automobile.

### DETAILED DESCRIPTION OF THE INVENTION

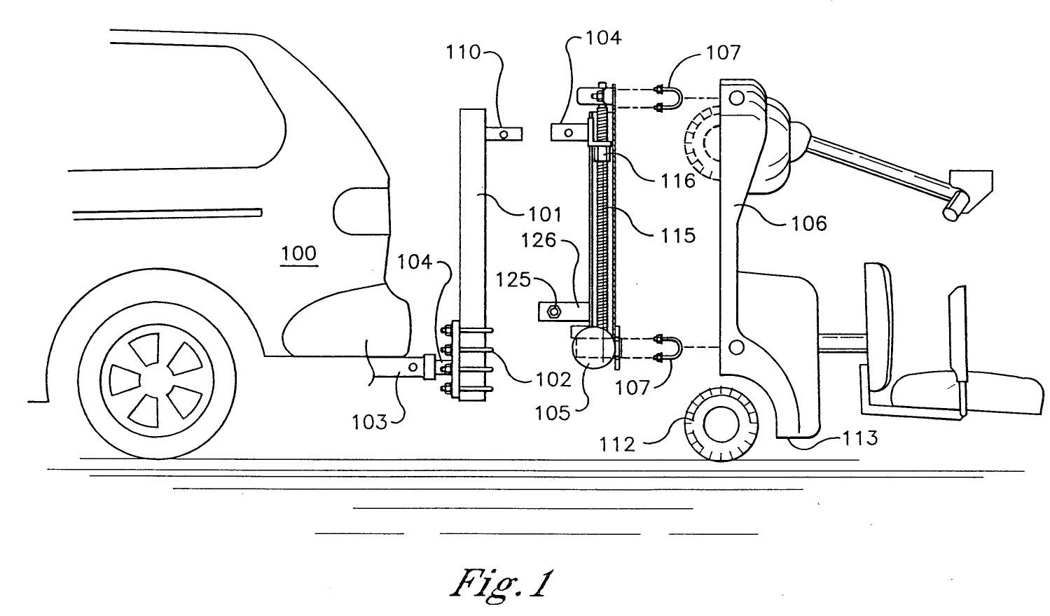

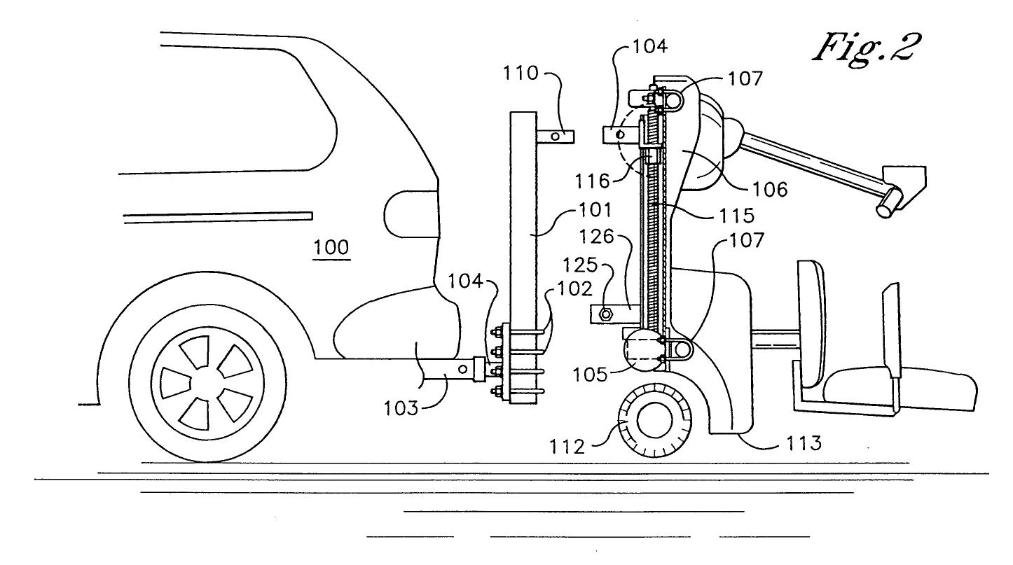

The present invention is shown in FIG. 1, consisting of a support arm 101 attached via U-bolts 102 to a support arm bracket 104, which is connected removably to a support arm hitch 103, a power lift unit 105 attached fixedly to a scooter 106 with U-bolts 107, the power lift unit 105 positioned such that it can be connected removably to the support arm 101 with a support pin receiver 109 and support pin 110. FIG. 2 shows the entire invention assembled and ready to be used.

In FIG. 2, the scooter 106 is tilted on its rear end 113 by rotating the scooter around the rear wheels 112. Optionally, the scooter rear end 113 possesses caster wheels or another supplemental support mechanism, not shown in the diagrams, to aid in keeping the scooter 106 in the correct orientation to be attached to the support arm 101.

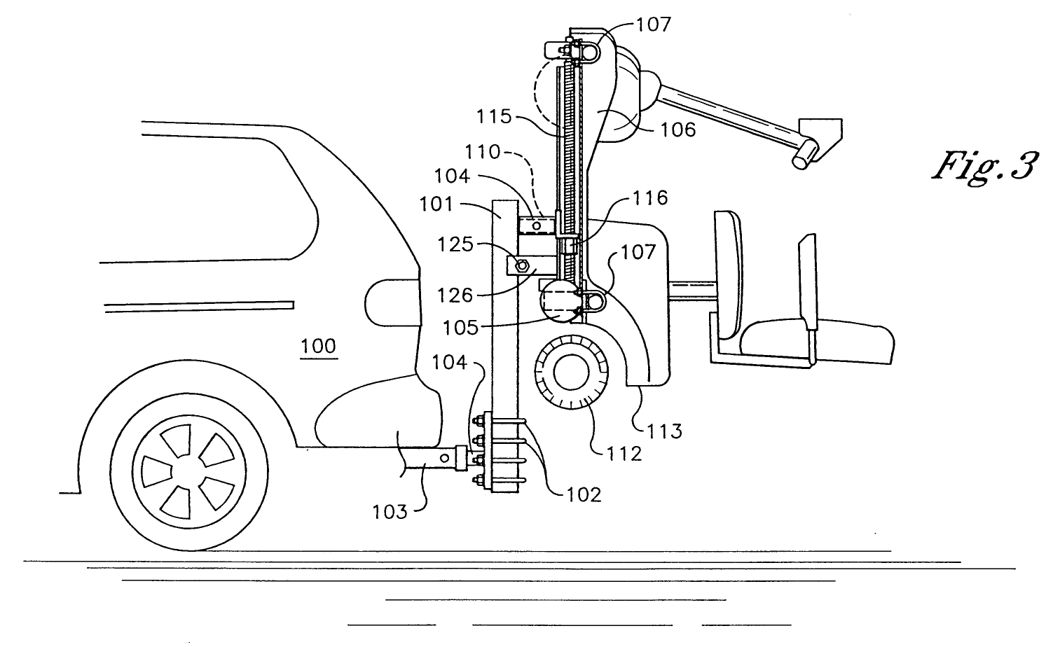

FIG. 3 shows the scooter 106 in the position of having been lifted off the ground by means of the invention. The support pin 110 has been inserted into the support pin receiver 109 on the support arm 101 and the power lift unit 105 has been activated such that the worm gear 115 has spun enough times to push the worm gear bracket 116 with the support pin 110 down the worm gear 115 and lift the weight of the scooter 106 into the air.

The height required to keep the scooter 106 clear of the ground is approximately 22 inches, which is higher than transporters/lifters in the state of the art.

To unload the scooter 06, reverse the procedure. Stop the carrying vehicle 100, turn on the power lift unit 105 in reverse mode to lower the scooter 106 to the ground. When the scooter 106 reaches the ground, the support pin 110 can be removed from the support pin receiver 109 by pushing the scooter 106 away from the carrying vehicle 100. The scooter can be rotated on the rear wheels 112 until the front end of the scooter is on the ground.

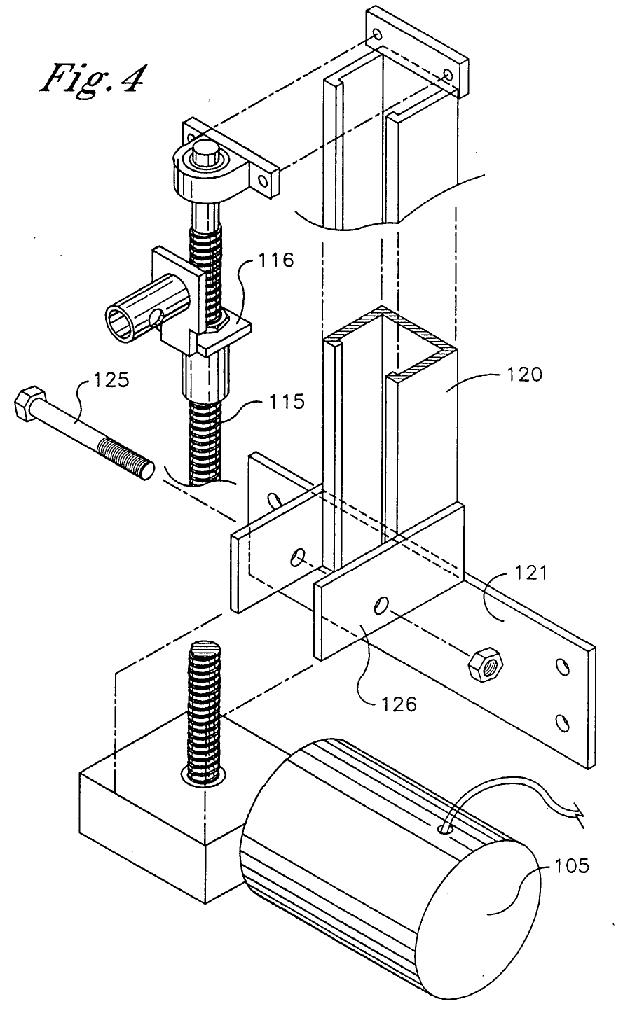

FIG. 4 shows the details of the power lift unit, with the worm gear track 120 and power unit support brackets 121. There is a stop bolt 125 and support frame 126 connected to the worm gear track 120 that provides support to the weight of the scooter 106 as it rides up the worm gear 115. The stop bolt 125 is inserted through two holes in the support frame 126 and secured with a nut, as shown.

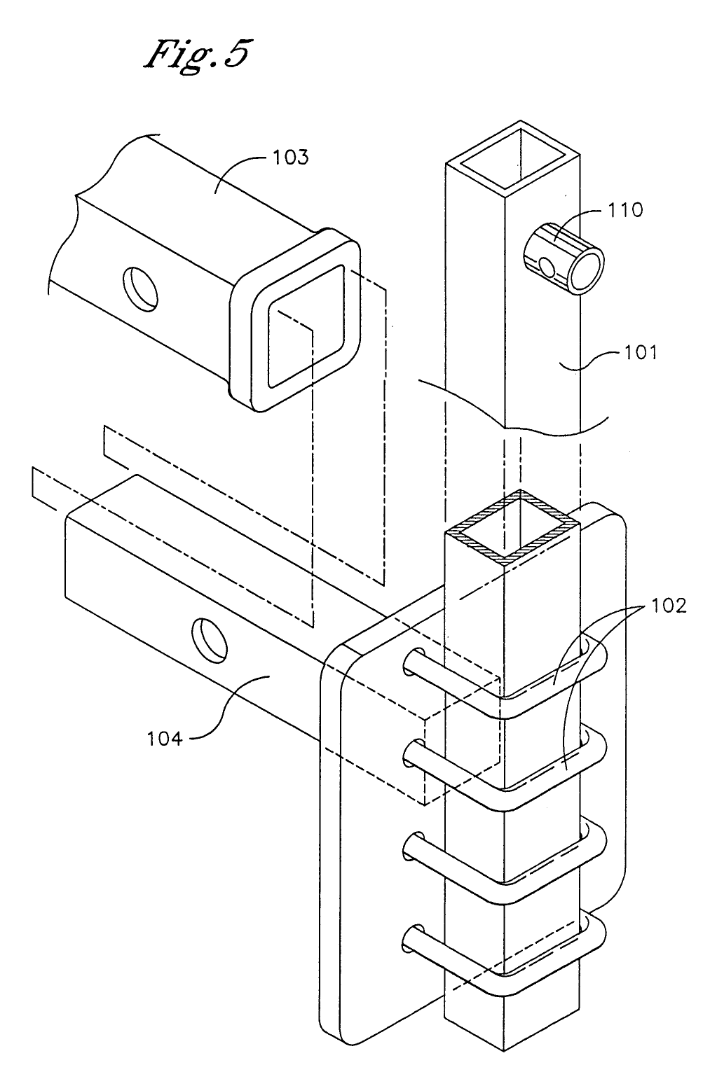

FIG. 5 shows the details of the support arm assembly attached to the carrying vehicle 100. Note that the shape of the support pin 110 and support pin receiver 109 are cylindrical. In an alternate embodiment, these shapes could be rectangular or semi-circular, or any other convenient shape.

While the present invention has been described above and a preferred embodiment of the invention has been identified, changes and substitutions of equivalent features can be made without departing from this invention. Those skilled in the art of scooter lifter will recognize that many variations of this described embodiment of the invention can be resorted to without leaving the boundaries of this specification and associated claims below.

What is claimed for this invention is:

1. a self-lifting device for scooters, said self-lifting device consisting of two assemblies,
the first assembly a support arm assembly, the support arm assembly attached removably to the rear bumper of an automobile, the support arm assembly comprised of a support arm hitch attached fixedly to the automobile, a support arm bracket connected removably to the support arm hitch, a support arm extending vertically from the support arm bracket, and a support pin receiver at the upper end of the support arm,
the second assembly a power lift assembly, the power lift assembly attached fixedly to the underside of a scooter, the power lift assembly consisting of a power lift motor and worm gear, the power lift motor and worm gear powered by the scooter's own battery, a worm gear bracket connected to the power lift motor and worm gear such that when the power lift motor and worm gear are turned on the worm gear bracket moves in one direction or the other along the worm gear, the worm gear bracket possessing a support pin, the support pin sized in such a way that it can be easily inserted into the support pin receiver of the support arm assembly, the support pin attached to the worm gear in such a way that the support pin is able to support the weight of the scooter when the support pin is inserted into the support pin receiver,
the self lifting device used by operating the power lift assembly such that the support pin bracket is moved to the end of the worm gear nearest the front of the scooter, rolling the scooter towards the carrying vehicle, rotating the scooter upright around its rear wheels such that the scooter is resting on its rear end, mating the support pin on the support pin bracket into the support pin receiver on the support arm assembly attached to the carrying vehicle and securing it removably, then operating the power lift assembly in such a manner that the support pin bracket travels towards the rear of the scooter on the worm gear and the scooter is lifted up to the desired height.

2. The self-lifting device of claim 1, where the support pin is connected to the support pin bracket such that the support pin can be folded out of the way when not being used to attach the scooter to the support arm assembly.

3. The self-lifting device of claim 1 where the scooter possesses caster wheels on its rear end such that it is easier to roll the scooter towards the carrying vehicle to be attached to the support arm assembly.

4. The self-lifting device of claim 1 where the support hitch is a standard trailer hitch.
